(19) United States
(12) Patent Application Publication
(10) Pub. No.: US 2013/0212169 A1
(43) Pub. Date: Aug. 15, 2013

(54) INFORMATION DISPLAY SYSTEM, INFORMATION DISPLAY CONTROL DEVICE, AND INFORMATION DISPLAY DEVICE

(71) Applicant: Seiichi Nakagawa, Kanagawa (JP)

(72) Inventor: Seiichi Nakagawa, Kanagawa (JP)

(73) Assignee: PANASONIC CORPORATION, Osaka (JP)

(21) Appl. No.: 13/878,791

(22) PCT Filed: Feb. 13, 2012
(86) PCT No.: PCT/JP2012/000942

§ 371 Date: Apr. 11, 2013

(30) Foreign Application Priority Data
Feb. 15, 2011 (JP) 2011-030035

(51) Int. Cl. H04L 29/06

(52) U.S. Cl. CPC H04L 67/42
USPC 709/203

(57) ABSTRACT

An information display system includes an information providing device 101 which has a remote UI server portion 103 and a remote frame buffer server portion c104, an information display device A 111 which has a remote UI player portion a113, a remote frame buffer player portion a114, a display part a116 and a remote frame buffer server portion a117, an information display device B 121 which has a remote frame buffer player portion b124 and a display part b126 and a display controller 131.

### TECHNICAL FIELD

The present invention relates to an information display system including an information providing device having at least one or more functions of navigation and reproduction of AV contents to provide information and at least one or more information display devices which display the provided information.

### BACKGROUND ART

Usually, a computer system is known in which a computer user is dynamically assigned to a remote computer resource to manage a network irrespective of a remote viewer protocol used by a user (for instance, see patent document 1).

Further, at present, car navigation devices or car AV devices are popularized which have a display unit such as a liquid crystal installed and used in a vehicle room and an input unit such as a touch panel in motor vehicles. In a part of these devices, for the purpose of easiness in installation, a plurality of information display devices having display units and information providing devices having information providing units may be occasionally configured respectively in separate forms and installed.

### PRIOR ART DOCUMENT

### Patent Document

Patent document 1: JP-T-2010-521761

### SUMMARY OF THE INVENTION

### Problems to be Solved by the Invention

When the information display device and the information providing device are configured respectively in separate forms, there is a plurality of systems as a method for realizing a user interface. A first system thereof is a (remote UI) system that a script sent from the information providing device is executed in the information display device to realize the user interface. A second system is a (remote frame buffer) system that a display image sent from the information providing device is displayed in the information display device to realize the user interface. Usually, protocols respectively suitable for the devices are selected from a plurality of protocols for executing the systems respectively to realize the user interface.

However, in the usual method, a problem arises that when the information display device does not have the protocol corresponding to that stored in the information providing device, or when the corresponding protocol is already used, the information providing device cannot be connected to the information display device, so that the user interface cannot be realized.

The present invention is devised to solve the usual problem and it is an object of the present invention to provide an information display system in which even when an information display device does not have a protocol corresponding to that stored by an information providing device, or when the corresponding protocol is already used, the information providing device can be connected to the information display device.

### Means for Solving the Problems

In order to achieve the above-described object, the present invention provides an information display system mounted on a vehicle. The information display system includes a first information display device connected to an image providing device having a server portion which transmits a script describing display parts for realizing a user interface corresponding to functions of the device of its own and a display image of the user interface, and including a player portion that displays a display image formed by processing the script or the display image transmitted by the information providing device and a server portion that transmits the display image, a second information display device including a player portion which displays the display image transmitted by the information providing device or the first display device, and an information display control device that controls the information providing device, the first image display device and the second image display device. The image display controller includes a control portion which changes connections of the server portions and the player portions between the devices in accordance with the using states of the server portions and the player portions respectively provided in the information providing device, the first information display device and the second information display device.

### Advantageous Effects of the Invention

According to the present invention, even when the information display device does not have the protocol corresponding to the protocol stored by the information providing device, or even when the corresponding protocol is already used, the information providing device can be effectively connected to the information display device.

### BRIEF DESCRIPTION OF THE DRAWINGS

FIG. 1 is a block diagram showing a structure of an information display system in an embodiment of the present invention.

FIG. 2 is a diagram showing contents of information stored in a database of the information display system in the embodiment of the present invention.

FIG. 3 is a flowchart for explaining an operation of the information display system in the embodiment of the present invention.

### MODE FOR CARRYING OUT THE INVENTION

### Embodiment

Now, an information display system in an embodiment of the present invention will be described below by referring to the drawings.

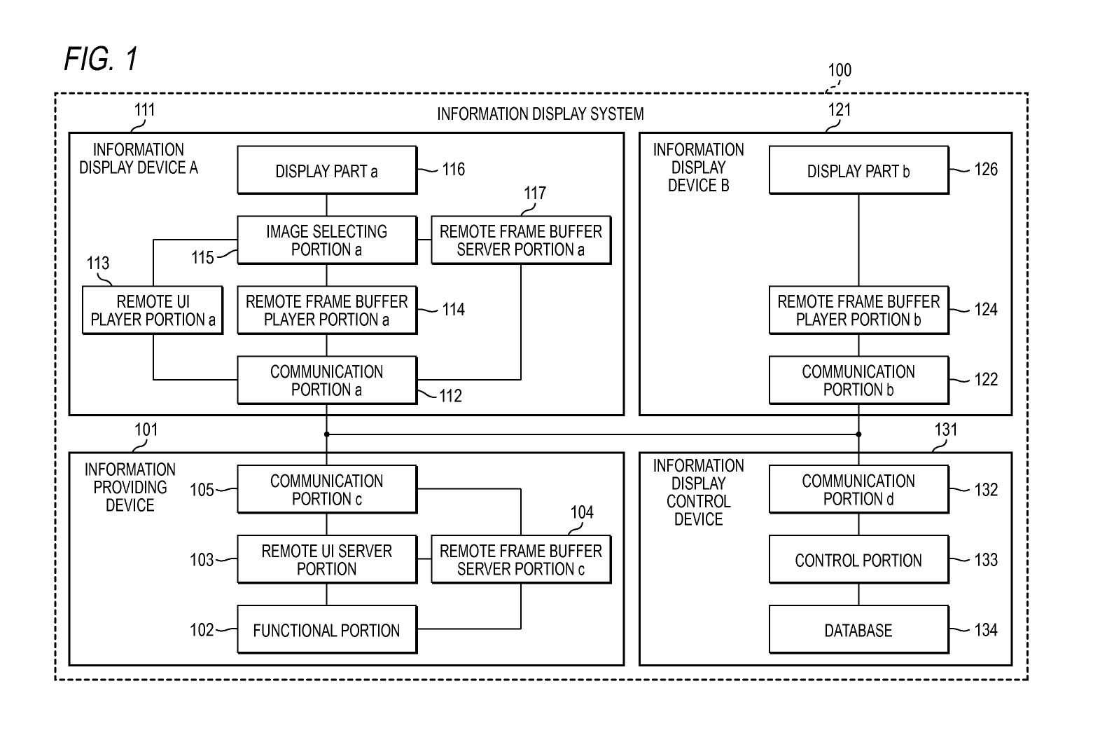

FIG. 1 is a block diagram showing the structure of the information display system in the embodiment of the present invention. The information display system 100 of the embodiment of the present invention includes an information providing device 101 having an information terminal device, an information display device A 111 as a first information display device, an information display device B 121 as a second information display device and an information display control device 131. The present embodiment shows an example of a case that the information display system is formed in, for instance, an indoor part of a motor vehicle.

The information providing device 101 has at least one or more functions such as navigation and reproduction of AV contents to provide information. The information providing device 101 includes, for instance, a navigation device having no display screen, a CD player device, a DVD player device, a BD player device, a TV tuner, a mobile telephone, a mobile terminal or the like.

The information display device A 111 and the information display device B 121 serve to display the information provided from the information providing device 101. The information display device A 111 and the information display device B 121 include, for instance, a navigation device (or system) having a display screen, a rear display device (or system), a mobile telephone, a smart phone, a tablet terminal, a portable audio device or the like.

Since the information providing device 101, the information display device A 111 and the information display device B 121 are configured respectively in separate forms, a degree of freedom in an installed position in the indoor side of the vehicle is advantageously obtained or any of them is easily taken outside the vehicle.

The information providing device 101 executes functions of the device of its own to communicate a user interface thereof in a plurality of protocols. The information providing device 101 includes a functional portion 102 which actually provides the functions of the device of its own, a remote UI server portion 103, a remote frame buffer server portion c104 and a communication portion c105. Here, the information providing device 101 includes the remote UI server portion 103 as a user interface server portion and the remote frame buffer server portion c 104 as a frame buffer server portion.

The functional portion 102 carries out the functions of the information providing device, and includes, for instance, a CPU (a processor) which executes a navigation function, a microcomputer having a memory such as a ROM, a RAM or the like and a communication unit such as a CD/DVD/BD deck, a TV tuner and a mobile telephone.

Even when the functional portion 102 is a general-purpose CPU to execute a program supplied from an external part, the functional portion can similarly carry out the above-described function. Further, even when the functional portion 102 communicates with an external device to control the external device, the functional portion can similarly carry out the above-described function.

The remote UI server portion 103 is a storage device such as a flash memory which accumulates at least one or more scripts forming display images displayed on the information display device A 111 and the information display device B 121 to control the functional portion 102. The remote UI server portion 103 provides the scripts to the communication portion c105 in accordance with requests from the information display device A 111 and the information display device B 121.

Even when the remote UI server portion 103 accumulates not only the scripts, but also data such as videos or images forming other display images, the remote UI server portion can similarly carry out the above-described functions.

Further, even when a non-volatile storage device such as an HDD or a volatile storage device such as a DRAM is used as the remote UI server portion 103, or even when a microcomputer having a CPU, a ROM, a RAM or the like is combined therewith to carry out a higher process, the remote UI server portion can similarly carry out the above-described functions.

The remote frame buffer server portion c104 is a microcomputer having, for instance, a CPU, a ROM, a RAM or the like which forms the display images displayed on the image display device A 111 and the image display device B 121 to provide the display images. The remote frame buffer server portion c104 controls the functional portion 102 to provide the display images to the communication portion c105 in accordance with requests from the information display device A 111 and the information display device B 121.

When the remote UI server portion 103 and the remote frame buffer server portion 104c are mounted by software and operated by the same CPU, the remote UI server portion and the remote frame buffer server portion can similarly carry out the above-described functions.

The communication portion c105 receives the scripts sent from the remote UI server portion 103 or the display images sent from the remote frame buffer server portion c104 and transmits the scripts or the display images to the information display device A 111 or the information display device B 121. The communication portion c105 is, for instance, an Ethernet (a registered trademark) controller.

Further, as for a communication system of the communication portion c105, as long as the scripts or the display images can be sent to the information display device A 111 or the information display device B 121, even other wired communication system such as a start/stop communication system or a wireless communication system such as IEEE802.11b can be similarly carried out.

Otherwise, as for a communication function of the communication portion c105, the communication portion may communicate not only the scripts or the display images, but also other videos or images, or may communicate information of other use than the present invention to the information display device A 111 or the information display device B 121 or other device except it or may carry out a bidirectional communication.

The information display device A 111 receives the information from the information providing device 101 in the plurality of protocols and retransmits the information in an arbitrary protocol. The information display device A 111 includes a communication portion a112, a remote UI player portion a113, a remote frame buffer player portion a114, an image selecting portion a115, a display part a116 and a remote frame buffer server portion a117. Here, the information display device A 111 includes the remote UI player portion a113 and the remote frame buffer player portion a114 as a player portion and the remote frame buffer server portion a117 as a server portion.

The communication portion a112 receives the scripts or the display images transmitted from the information providing device 101 to send the received information to the remote UI player portion a113 or the remote frame buffer player portion a114 in accordance with the protocol. Further, the communication portion a112 transmits the display image received from the remote frame buffer server portion a117 to the information display device B 121. Further, the communication portion a112 sends an instruction from the information display control device 131 to the remote UI player portion a113, the remote frame buffer player portion a114 and the remote frame buffer server portion a117. The communication portion a112 is, for instance, the Ethernet (the registered trademark) controller.

Further, as for a communication system of the communication portion a112, as long as the above-described transmission and reception can be carried out, even other wired communication system such as a start/stop communication system or a wireless communication system such as IEEE802.11b can be likewise carried out.

Otherwise, as a communication function of the communication portion a112, the communication portion carries out not only the above-described transmission and reception, but also may receive other videos or images or receive information of other use than the present invention from the information providing device 101 or other device than the information providing device 101.

The remote UI player portion a113 interprets the script received from the communication portion a112 to form an image to be displayed on the display part a116 and sends the image to the image selecting portion a115. The remote UI player portion a113 is a microcomputer having, for instance, a CPU, a ROM, a RAM or the like. For instance, in this case, the CPU executes a computer program stored in the ROM by using the RAM as an operating area to realize the above-described operation.

The remote frame buffer player portion a114 processes the display image received from the communication portion a112 to form the image to be displayed on the display part a116 and sends the image to the image selecting portion a115. The remote frame buffer player portion a114 is a microcomputer having, for instance, a CPU, a ROM, a RAM or the like. For instance, in this case, the CPU executes a computer program stored in the ROM by using the RAM as an operating area to realize the above-described operation.

The image selecting portion a115 selects the images sent from the remote UI player portion a113 and the remote frame buffer player portion a114 and sends the image to the display part a116 or the remote frame buffer server portion a117. The image selecting portion a115 is, for instance, a switch. The image selecting portion a115 may have other image input source than the remote UI player portion a113 and the remote frame buffer player portion a114 or other image output end than the display part a116 and the remote frame buffer server portion a117. Further, even when the image selecting portion a115 has a combining function for combining together a plurality of input images to send the combined image to the output end, the image selecting portion can likewise carry out the above-described functions.

The display part a116 serves to display the image sent from the image selecting portion a115 and is, for instance a display such as a liquid crystal monitor.

Further, the display part a116 may be used to display an image sent from other part than the image selecting portion a115. Further, even when the display part a116 outputs an audio as a speaker, the display part a116 can similarly carry out the above-described function.

The remote frame buffer server portion a117 provides the display image to be displayed on the information display device B 121, and is a microcomputer having, for instance, a CPU, a ROM, a RAM or the like. The remote frame buffer server portion a117 provides the display image sent from the image selecting portion a115 to the communication portion a112 in accordance with a request from the information display device B 121. The information display device A 111 may have a remote UI server portion.

When the remote UI player portion a113, the remote frame buffer player portion a114 and the remote frame buffer server portion a117 are mounted by software and operated by the same CPU, the remote UI player portion a113, the remote frame buffer player portion a114 and the remote frame buffer server portion a117 can similarly carry out the above-described functions.

The information display device B 121 displays the information transmitted from the information providing device 101 or the information display device A 111. The information display device B 121 includes a communication portion b122, a remote frame buffer player portion b124 and a display part b126. The information display device B 121 includes the remote frame buffer player portion b124 as a player portion.

The communication portion b122 receives the scripts or the display images transmitted from the information providing device 101 and the information display device A 111 to send the received information to the remote frame buffer player portion b124 in accordance with the protocol. Further, the communication portion b122 sends an instruction from the information display control device 131 to the remote frame buffer player portion b124. The communication portion b122 is, for instance, the Ethernet (the registered trademark) controller.

Further, as for a communication system of the communication portion b122, as long as the above-described transmission and reception can be carried out, even other wired communication system such as a start/stop communication system or a wireless communication system such as IEEE802.11b can be similarly carried out.

Otherwise, as a communication function of the communication portion b122, the communication portion carries out not only the above-described transmission and reception, but also may receive other videos or images or receive information of other use than the present invention from the information providing device 101 or other device than the information providing device 101.

The remote frame buffer player portion b124 processes the display image received from the communication portion b122 to form an image to be displayed on the display part b126 and sends the image to the image display part b126. The remote frame buffer player portion b124 is a microcomputer having, for instance, a CPU, a ROM, a RAM or the like. For instance, in this case, the CPU executes a computer program stored in the ROM by using the RAM as an operating area to realize the above-described operation. The information display device B121 may have a remote UI player portion.

The display part b126 serves to display the image sent from the remote frame buffer player portion b124 and is, for instance, a display such as a liquid crystal monitor.

Further, the display part b126 may be used to display an image sent from other part than the remote frame buffer player portion b124. Further, even when the display part b126 outputs an audio as a speaker, the display part b126 can similarly carry out the above-described function.

The information display control device 131 manages the using states of the server portions and the player portions of the devices respectively to control connections between the devices. The information display control device 131 includes a communication portion d132, a control portion 133 and a database 134 as a storing portion.

The communication portion d132 sends an instruction from the control portion 133 to the information display device A 111 and the information display device B 121. The communication portion d132 is, for instance, the Ethernet (the registered trademark) controller.

Further, as for a communication system of the communication portion d132, as long as the above-described transmission can be carried out, even other wired communication system such as a start/stop communication system or a wireless communication system such as IEEE802.11b can be similarly carried out.

Otherwise, as a communication function of the communication portion d132, the communication portion may communicate not only the instruction to the information display device A 111 and the information display device B 121, but also other videos or images, or may communicate information of other use than the present invention to the information display device A 111, the information display device B 121 or other device than the information display device A or B or may carry out a bidirectional communication.

The control portion 133 searches contents of the database 134 and refers thereto to instruct a connection end to the information display device A 111 and the information display device B 121 through the communication portion d132. The control portion 133 is a microcomputer having, for instance, a CPU, a ROM, a RAM or the like. For instance, in this case, the CPU executes a computer program stored in the ROM by using the RAM as an operating area to realize the above-described operations.

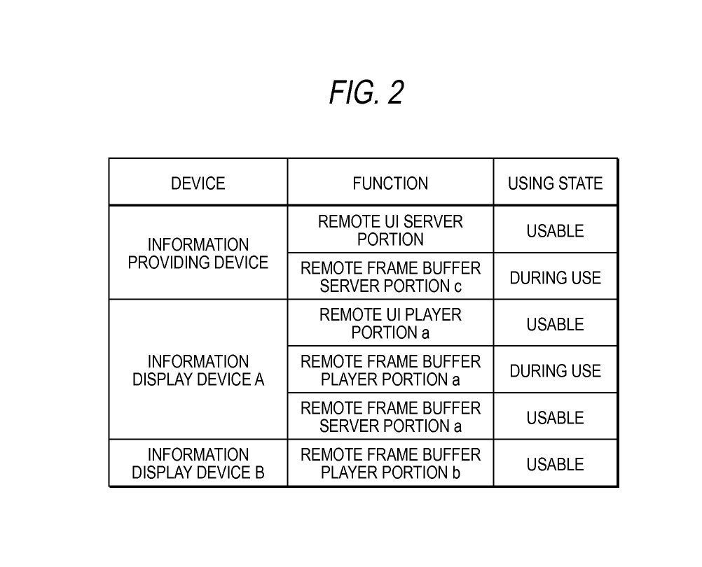

As shown in FIG. 2, the database 134 is a storage device such as a flash memory which stores a list of server functions and player functions of the protocols respectively provided in the information providing device 101, the information display device A 111 and the information display device B 121 and the using states thereof (use permission or inhibition states). Namely, the database 134 stores information respectively of the using states of the server portions and the player portions of the devices. Further, the database 134 provides the holding information respectively of the devices, the functions and the using states to the control portion 133 and can change the information from the control portion 133.

Even when a non-volatile storage device such as an HDD or a volatile storage device such as a DRAM is used as the database 134, or even when a microcomputer having a CPU, a ROM, a RAM or the like is combined therewith to carry out a higher process, the database can similarly carry out the above-described functions.

The control portion 133 and the database 134 included in the information display control device 131 do not need to be formed as separate bodies from the information providing device 101, the information display device A 111 and the information display device B 121. For instance, the information providing device 101 may include the control 133 and the database 134 and the communication portion d132 may be the same as the communication portion c105.

A processing operation of the display system formed as described above will be described below.

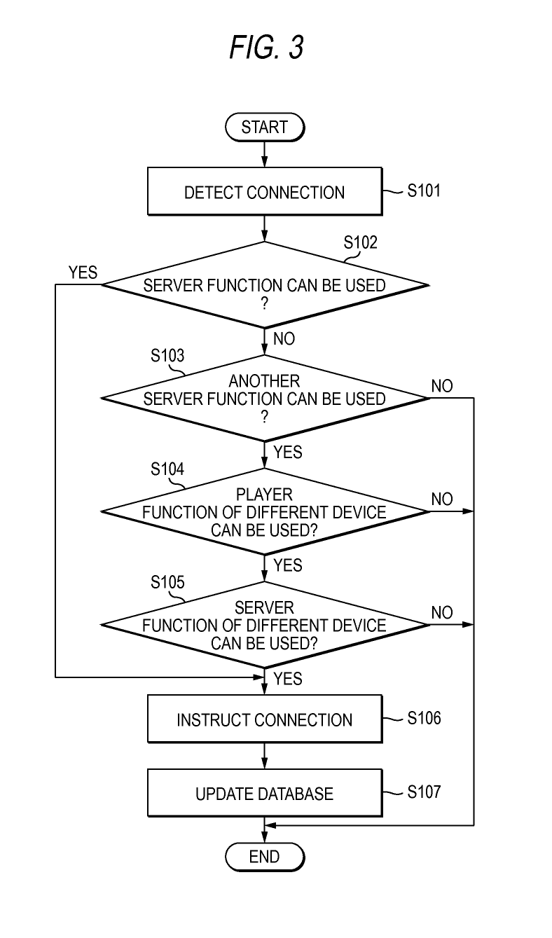

FIG. 3 is a flowchart of a control process carried out by the control portion 133 forming the information display system in the embodiment of the present invention.

Initially, in an initial state, the information providing device 101, the information display device A 111 and the information display control device 131 are supposed to be connected together, and the information display device B 121 is not supposed to be connected. At this time, the database 134 has the contents shown in FIG. 2.

Under this state, when the information display device B 121 is connected, the control portion 133 carries out the process of the flowchart shown in FIG. 3.

Firstly, in step S101, when the device is newly connected to the information display system, the control portion 133 detects that the device connected to the device of its own is the information display device B 121 through the communication portion d132.

Then, the control portions 133 decides whether or not the server function of the information providing device 101 having the same protocol as that of the player function of the information display device B 121 which is connected this time can be used (step S102). When the server function can be used (YES in the step S102), the control portion 133 instructs the server function (the remote frame buffer server portion a117) of the information providing device 101 to be connected to the player function (the remote frame buffer player portion b124) of the information display device B 121 through the communication portion d132 (S106). Then, the control portion 133 updates corresponding items of the database 134 to during using (step S107) to finish the process.

In the example of this time, according to the database 134, the player function of the information display device B 121 is a remote frame buffer player function. However, since a remote frame buffer server function of the information providing device 101 is during use, the control portion 133 decides NO in the step 102 to advance to step S103.

In the step S103, the control portion 133 decides whether or not the information providing device 101 or other device (the information display device A 111) has other usable server function. Here, when there is no usable server function, the control portion 133 decides that the information display device B 121 cannot be connected to the information providing device 101 to finish the process (NO in the step S103).

In the example of this time, according to the database 134, since a remote frame buffer server function of the information display device A 111 is usable, the control portion 133 decides YES in the step 103 to advance to step S104.

In the step S104, the control portion 133 decides whether or not the device having the usable server function in the step S103 has a usable player function. Here, when there is no usable player function, the control portion 133 decides that the information display device B 121 cannot be connected to the information providing device 101 to finish the process (NO in the step S104).

In the example of this time, according to the database 134, a remote frame buffer player function of the information display device A 111 is during use, however, a remote UI player function is usable. Accordingly, the control portion 133 decides YES in the step S104 to advance to step S105.

In the step S105, the control portion 133 decides whether or not the server function of the information providing device 101 having the same protocol as that of the usable player function in the step S104 can be used. When the server function cannot be used, the control portion 133 decides that the information display device B 121 cannot be connected to the information providing device 101 to finish the process (NO in the step S105).

In the example of this time, according to the database 134, since a remote UI server function of the information providing device 101 can be used, the control portion 133 decides YES in the step S105. Then, the control portion 133 instructs the remote frame buffer server portion a117 to be connected to the remote frame buffer player portion b124, and the remote UI server portion 103 to be connected to the remote UI player portion a113 through the communication portion d132 (step S106). Then, the control portion 133 updates corresponding items during using (step S107) and then finishes the process.

As described above, in the present embodiment, the information providing device 101 is provided which includes the functional portion 102, the remote UI server portion 103, the remote frame buffer server portion c104 and the communication portion c105. Further, the information display device A 111 is provided which includes the communication portion a112, the remote UI player portion a113, the remote frame buffer player portion a114, the image selecting portion a115, the display part a116 and the remote frame buffer server portion a117. Further, the information display device B 121 is provided which includes the communication portion b122, the remote frame buffer player portion b124 and the display part b126. Further, the information display control device 131 is provided which includes the communication portion d132, the control portion 133 and the database 134. According to the information display system having these devices, the information display device B 121 can be connected to the information providing device 101 through the information display device A 111 to realize the user interface.

At this time, in accordance with the using states of the server functions and the player functions respectively provided in the devices, the connections of the server functions and the player functions between the devices can be dynamically changed and a connection can be achieved which meets the server function and the player function having a usable protocol. Namely, in accordance with the states of the devices of the information display system, when the information providing device is connected to the information display device so as to be adapted thereto, the user interface provided by the information providing device can be realized in the information display device.

Thus, according to the present embodiment, since the database is provided which manages the server functions and the player functions, the devices that cannot be simply connected can be connected to each other and the user interface which meets the device as an object to be connected can be realized.

For instance, a case is assumed that the information display system of the present embodiment is formed in an interior of a motor vehicle, the information display control device is provided in the interior of the motor vehicle and an information terminal device such as a mobile terminal is carried and used as the information providing device or the information display device. In this case, in order to connect the information terminal device to other information providing device or information display device, the information terminal device is detected by the information display control device to decide the using states (the use permission or inhibition states) of the server functions and the player functions between the devices to be connected. In accordance with the decided result, both the devices are connected together by using the server functions and the player functions of the usable devices (the device of its own or other device) to realize the user interface. By such an operation of the present embodiment, the information terminal device carried to the interior of the motor vehicle can be normally operated, information provided by the information terminal device can be displayed on the information display device in the vehicle or information from the information providing device in the vehicle can be displayed on the information terminal device.

As described above, in the present embodiment, especially when a mobile electronic device is used as a portable device and connected to other device previously set in the vehicle, an outstanding effect is obtained. Further, according to the present embodiment, a portable device whose connecting method is merely partly provided or devices of different generations may be connected.

Various forms of the embodiment according to the present invention include below-described structures are included.

In an information display system mounted on a vehicle, the information display system including a first information display device connected to an information providing device having a server portion which transmits a script describing display parts for realizing a user interface corresponding to functions of the device of its own or a display image of the user interface, and having a player portion which displays a display image formed by processing the script or the display image transmitted by the information providing device and a server portion which transmits the display image, a second information display device having a player portion which displays the display image transmitted by the information providing device or the first information display device and an information display control device which controls the information providing device, the first information display device and the second information display device, wherein the information display control device has a control portion which changes connections of the server portions and the player portions between the devices respectively in accordance with using states of the server portions and the player portions respectively provided in the information providing device, the first information display device and the second information display device.

According to the above-described structure, the connection meeting the server portion and the player portion of the usable protocol can be achieved in accordance with the using states of the server portions and the player portions respectively provided in the devices. Accordingly, even when the information display device does not have the protocol corresponding to that stored by the information providing device, or even when the corresponding protocol is already used, the information providing device can be connected to the information display device.

In the above-described information display system, the information display control device has a storing portion which stores information of the using states of the server portions and the player portions, and the control portion refers to the information of the using states and instructs the server portion of the information providing device to be connected to the player portion of the first information display device or the second information display device in accordance with the using states of the server portions and the player portions of protocols that can be used respectively in the information providing device, the first information display device and the second information display device.

In an information display control device which controls a connection between an information providing device and an information display device in an information display system mounted on a vehicle, the information display control device including a storing portion which stores information of using states of server portions provided in the information providing device or the information display device to transmit a script describing display parts for realizing a user interface corresponding to functions of the device or a display image of the user interface and player portions provided in the information display device to display a display image formed by processing the script or the display image and a control portion which refers to the information of the using states and instructs the server portion of the information providing device to be connected to the player portion of the information display device in accordance with the using states of the server portions and the player portions of protocols that can be used respectively in the information providing device and the information display device.

In the above-described information display control device, the storing portion stores the information of the using states of the server portions of the information providing device, the player portions and the server portion of the first information display device and the player portion of the second information display device in the information display device, when the server portion and the player portion do not exist which can be directly connected together under the protocol that can be used respectively in the server portions of the information providing device and the player portion of the second information display device, the control portion instructs a connection to be carried out through the player portions and the server portion of the first information display device.

In an information display device which displays information provided from an information providing device in an information display system mounted on a vehicle, the information display device including a player portion having at least one of a user interface player portion which displays a display image formed by processing a script describing display parts for realizing a user interface corresponding to functions of the information providing device and a frame buffer player portion which displays a display image of the user interface as a player portion which displays the display image of the information transmitted by the information providing device, a server portion having at least one of a user interface server portion which transmits the display image formed by processing the script and a frame buffer server portion which transmits the display image of the user interface as a server portion which transmits the display image and a communication portion which changes connections of the player portion and the server portion, the information providing device and other information display device to make a communication in accordance with an instruction from an information display control device.

In an information display device which displays information provided from an information providing device in an information display system mounted on a vehicle, the information display device including a player portion having at least one of a user interface player portion which displays a display image formed by processing a script describing display parts for realizing a user interface corresponding to functions of the information providing device and a frame buffer player portion which displays a display image of the user interface as a player portion which displays the display image of the information transmitted by the information providing device and a communication portion which changes connections of the player portion and the information providing device and other information display device to make a communication in accordance with an instruction from an information display control device.

In an information providing device which provides information to an information display device in an information display system mounted on a vehicle, the information providing device including a server portion having at least one of a user interface server portion which transmits a script describing display parts for realizing a user interface corresponding to functions of the device of its own and a frame buffer server portion which transmits a display image of the user interface and a communication portion which allows the server portion to be connected to the information display device to make a communication in accordance with an instruction from an information display control device.

It is to be anticipated by the present invention and included within a scope to be protected that a person with ordinary skill in the art makes various changes and applications in accordance with the description of the specification and a known technique without deviating from the purpose and the scope of the present invention. Further, component elements in the above-described embodiment may be arbitrarily combined within a scope that does not deviate from the purpose of the present invention.

This application is based on Japanese Patent Application (Japanese Patent Application No. 2011-030035) filed on Feb. 15, 2011, and the contents of which are incorporated herein as a reference.

### INDUSTRIAL APPLICABILITY

The present invention is available for the information display system or the like which includes at leas one or more information display devices connected to the information providing device having at least one or more functions of navigation and reproduction of AV contents to provide information and displaying the provided information. For instance, the present invention is available for the information display system in a system mounted on a vehicle such as a car navigation device or a car AV device in which the information display device can be carried outside the vehicle or a system mounted on the vehicle in which a portable device such as the information terminal device carried to the vehicle is connected to a device mounted on the vehicle.

### DESCRIPTION OF REFERENCE NUMERALS AND SIGNS

100 information display system

101 information providing device

102 functional portion

103 remote UI server portion

104 remote frame buffer server portion c

105 communication portion c

111 information display device A

112 communication portion a

113 remote UI player portion a

114 remote frame buffer player portion a

115 image selecting portion a

116 display part a

117 remote frame buffer server portion a

121 information display device B

122 communication portion b

124 remote frame buffer player portion b

126 display part b

131 information display control device

132 communication portion d

133 control portion

134 database

1. An information display system mounted on a vehicle, the information display system comprising:
a first information display device that is connected to an information providing device having a server portion which transmits a script describing display parts for realizing a user interface corresponding to functions of the device of its own or a display image of the user interface, and that includes a player portion which displays a display image formed by processing the script or the display image transmitted by the information providing device and a server portion which transmits the display image;
a second information display device that includes a player portion which displays the display image transmitted by the information providing device or the first information display device; and
an information display control device that controls the information providing device, the first information display device, and the second information display device,
wherein the information display control device includes a control portion which changes connections of the server portions and the player portions between the devices respectively in accordance with using states of the server portions and the player portions respectively provided in the information providing device, the first information display device, and the second information display device.

2. The information display system according to claim 1, wherein the information display control device includes a storing portion that stores information of the using states of the server portions and the player portions;
wherein the control portion refers to the information of the using states and instructs for connecting the server portion of the information providing device to the player portion of the first information display device or the player portion of the second information display device in accordance with the using states of the server portions and the player portions of protocols being usable respectively in the information providing device, the first information display device, and the second information display device.

3. An information display control device which controls a connection between an information providing device and an information display device in an information display system mounted on a vehicle, the information display control device comprising:
a storing portion that stores information of using a state of a server portion provided in the information providing device or the information display device to transmit a script describing display parts for realizing a user interface corresponding to functions of the device or a display image of the user interface and information of using states of player portions provided in the information display device to display a display image formed by processing the script or the display image; and
a control portion that refers to the information of the using states and instructs for connecting the server portion of the information providing device to the player portion of the information display device in accordance with the using states of the server portion and the player portions of protocols being usable respectively in the information providing device and the information display device.

4. The information display control device according to claim 3, wherein the storing portion stores the information of the using states of the server portions of the information providing device, the player portion and the server portion of a first information display device and the player portion of a second information display device in the information display device; and
wherein when there are no server portion and player portion of protocols being directly usable respectively and directly connected together in the server portions of the information providing device and the player portion of the second information display device, the control portion instructs a connection through the player portion and the server portion of the first information display device.

5. An information display device which displays information provided from an information providing device in an information display system mounted on a vehicle, the information display device comprising:
a player portion that includes at least one of a user interface player portion which displays a display image formed by processing a script describing display parts for realizing a user interface corresponding to functions of the information providing device and a frame buffer player portion which displays a display image of the user interface, as a player portion which displays the display image of the information transmitted by the information providing device;
a server portion that includes at least one of a user interface server portion which transmits the display image formed by processing the script and a frame buffer server portion which transmits the display image of the user interface, as a server portion which transmits the display image; and
a communication portion that changes connections of the player portion and the server portion, the information providing device and other information display device in response to an instruction from an information display control device to make a communication.
